(19) United States
(12) Patent Application Publication
(10) Pub. No.: US 2003/0163921 A1
(43) Pub. Date: Sep. 4, 2003

(54) Multi-functional cutter

(76) Inventor: Chen-Tsung Tsai, Taiping City (TW)

Correspondence Address: Alan D. Kamrath, Rider, Bennett, Egan & Arundel, LLP, 333 South Seventh Street, Suite 2000, Minneapolis, MN, 55042, US

(21) Appl. No.: 10/172,897

(22) Filed: Jun. 17, 2002

(30) Foreign Application Priority Data
Mar. 4, 2002 (TW) 91202655

(51) Int. Cl. B26B 11/00

(52) U.S. Cl. 30/146; 30/125; 30/143

(57) ABSTRACT

A multi-functional cutter includes a handle, a stationary lower jaw secured to the handle, a first blade secured to the stationary lower jaw, a pivotal upper jaw connected with the handle, a second blade secured to the pivotal upper jaw so that the first and second blades face each other, and a third blade mounted on the stationary lower jaw. The multi-functional cutter may include a frame formed on the handle for holding a spare blade. The multi-functional cutter may include a cover movably mounted on the frame for concealing the spare blade. The multi-functional cutter may include a light source mounted on the handle.

### BACKGROUND OF INVENTION

1. Field of Invention

The present invention is related to a multi-functional cutter.

2. Related Prior Art

FIG. 6 shows a conventional electric pair of scissors 1 including a stationary blade 2 and a pivotal blade 3 that can be activated by means of a motor (not shown) that can be controlled by means of a switch 4. When actuated, the pivotal blade 3 is pivoted up and down in order to cooperate with the stationary blade 2 for scissoring a piece of paper or the like. However, this conventional electric pair of scissors 1 cannot be used to chop, cut or pare. Other cutters must be carried for cutting in other ways. This is inconvenient. Furthermore, this conventional electric pair of scissors 1 is not equipped with a light source for illumination of an area of a piece of paper or the like in which cutting is about to be or being performed.

The present invention is therefore intended to obviate or at least alleviate the problems encountered in use of the above-mentioned conventional electric pair of scissors.

### SUMMARY OF INVENTION

It is the primary objective of the present invention to provide a multi-functional cutter.

According to the present invention, a multi-functional cutter includes a handle, a stationary lower jaw secured to the handle, a first blade secured to the stationary lower jaw, a pivotal upper jaw connected with the handle, a second blade secured to the pivotal upper jaw so that the first and second blades face each other, and a third blade mounted on the stationary lower jaw.

The multi-functional cutter may include a frame formed on the handle for holding a spare blade.

The multi-functional cutter may include a cover movably mounted on the frame for concealing the spare blade.

The multi-functional cutter may include a light source mounted on the handle.

Other objects, advantages, and novel features of the invention will become more apparent from the following detailed description when taken in conjunction with the attached drawings.

### BRIEF DESCRIPTION OF DRAWINGS

The present invention will be described through detailed illustration of the preferred embodiment referring to the attached drawings wherein:

FIG. 1 is a perspective view of a multi-functional cutter according to the preferred embodiment of the present invention;

FIG. 2 is an exploded view of the multi-functional cutter according to the preferred embodiment of the present invention;

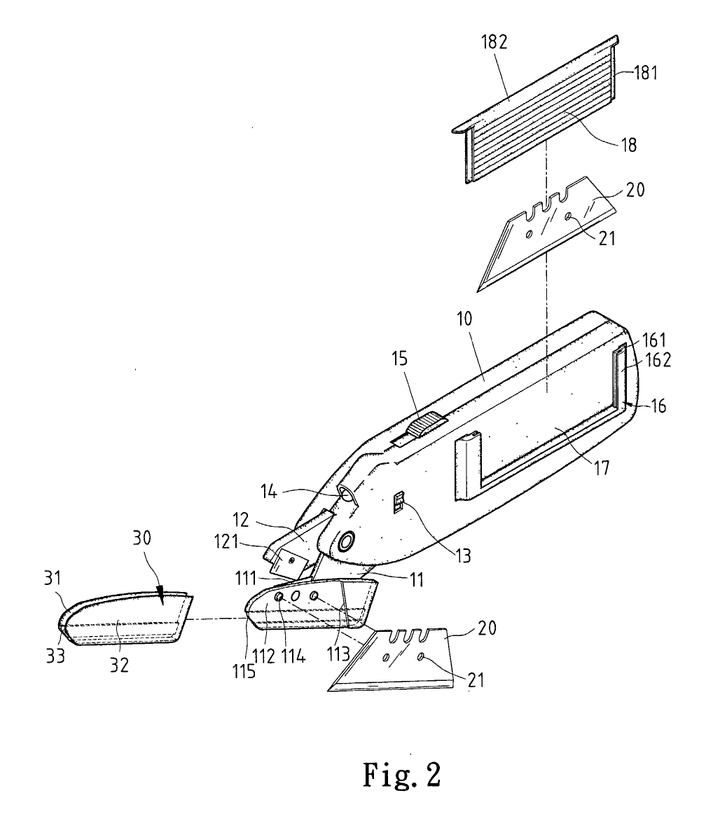

FIG. 3 is a cross-sectional view taken along a line3-3 in FIG. 1;

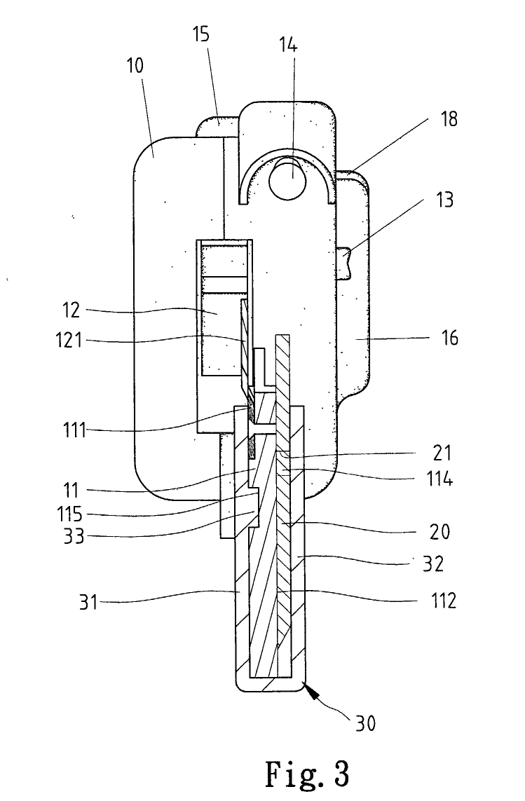

FIG. 4 is a side view of the multi-functional cutter according to the preferred embodiment of the present invention when used to cut;

FIG. 5 is a side view of the multi-functional cutter according to the preferred embodiment of the present invention when used to scissor; and

FIG. 6 is a perspective view of an electric pair of scissors according to prior art.

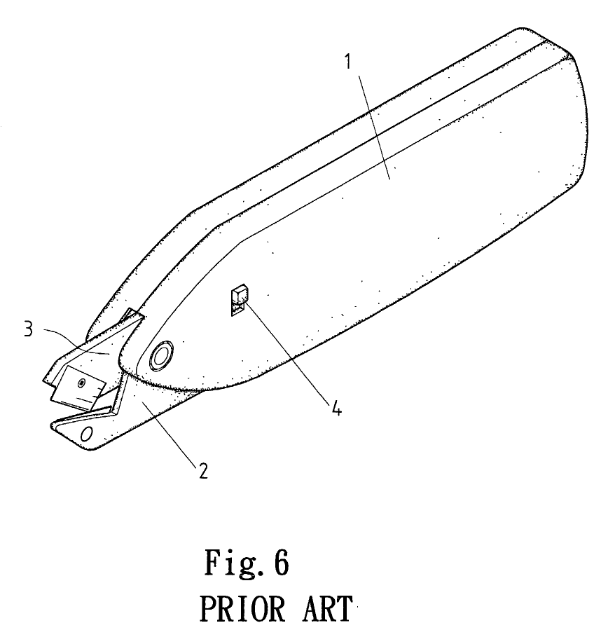

### DETAILED DESCRIPTION OF PREFERRED EMBODIMENT

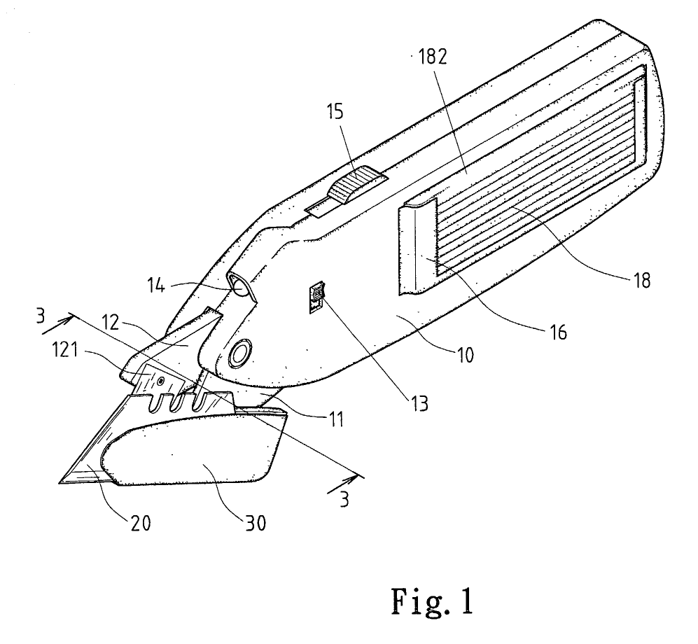

Referring to FIGS. 1˜3, according to the preferred embodiment of the present invention, a multi-functional cutter includes a handle 10, a stationary lower jaw 11 secured to the handle 10 and a pivotal upper jaw 12 connected with the handle 10. A blade 111 is secured to the stationary lower jaw 11. A blade 121 is secured to the pivotal upper jaw 12. The handle 10 is hollow in order to receive at least one motor (not shown) that is operatively connected with the pivotal upper jaw 12 in order to pivot the pivotal upper jaw 12 up and down. Thus, the multi-functional cutter can be used as an electric pair of scissors. The motor is controlled by means of a switch 13 mounted on the handle 10.

A flat holder 112 is formed on the stationary lower jaw 11. The holder 112 includes a first side on which a raised portion 113 and two bosses 114 are formed and a second side in which a groove 115 is defined.

A blade 20 includes two apertures 21 defined therein, a rear edge and a lower edge for cutting. The blade 20 is mounted on the holder 112 so that the rear edge thereof is located against the raised portion 13 of the holder 12. The blade 20 is retained on the holder 112 due to insertion of the bosses 114 in the apertures 21.

A sheath 30 includes a first side plate 31, a second side plate 32 and an intermediate plate via which the second side plates are connected with each other. A ridge 33 is formed on an internal side of the first side plate 31. The ridge 33 can be inserted in the groove 115, thus mounting the sheath 30 on the holder 112 for concealing the blade 20.

A frame 16 is formed on the handle 11. The frame 16 includes a horizontal ridge and two vertical ridges. A groove 161 is defined in a rim 162 projecting from each of the vertical ridges. The rims 162 are separate from the handle 11 by a distance equal to the thickness of a spare blade 20. The spare blade 20 can be put on the frame 16. The rims 162 avoid escaping of the spare blade 20 from the frame 16 laterally. A cover 18 includes two vertical edges 181 for insertion in the grooves 161 and an upper edge 182 for avoiding escaping of the spare blade 20 from the frame 16 vertically.

A light source 14 is mounted on the handle 10 near the upper pivotal jaw 12. The light source 14 is controlled by means of a switch 15 mounted on the handle 10.

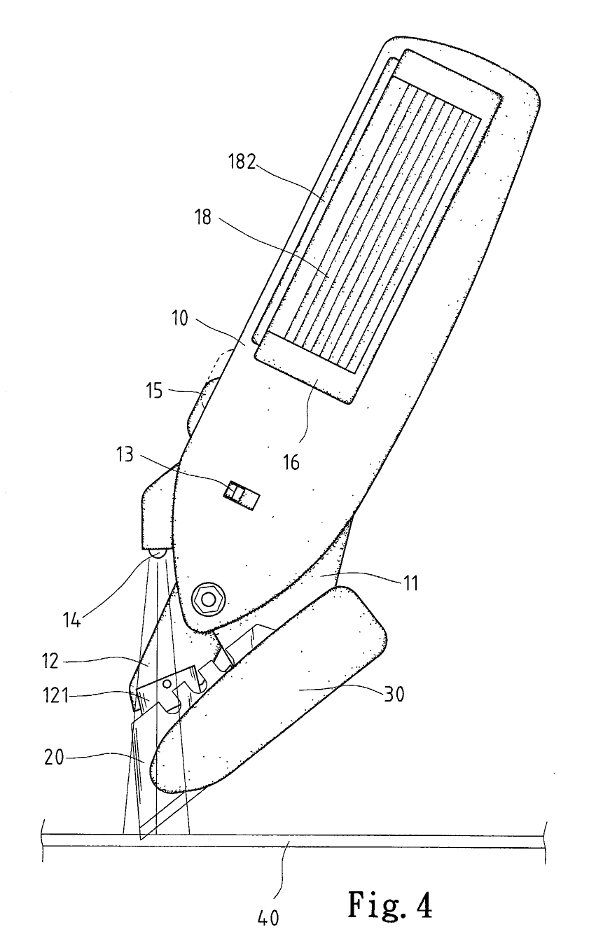

Referring to FIG. 4, the sheath 30 is moved relative to the holder 112 in a direction so as to expose a tip of the blade 20 for cutting. If the environment is dark, the light source 14 can be turned on for illumination of an area of a piece of paper or the like in which cutting is desired.

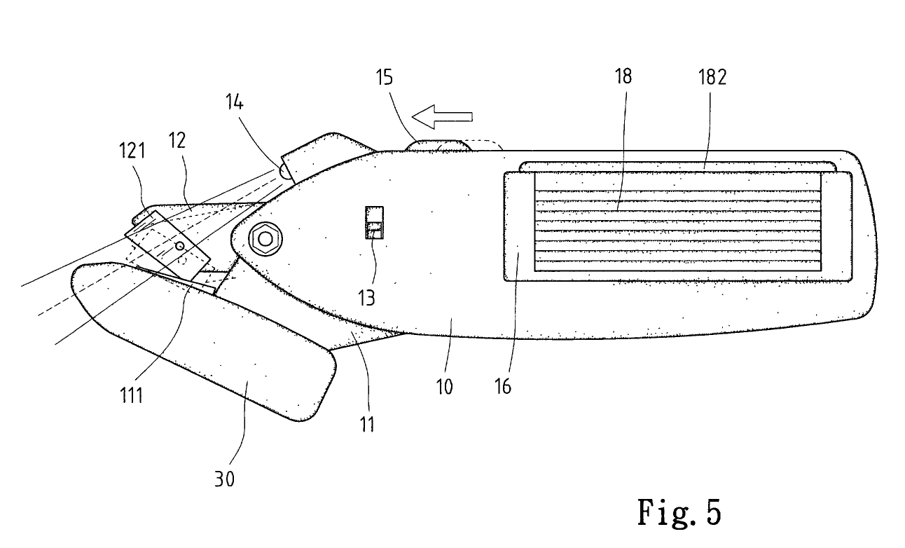

Referring to FIG. 5, the sheath 30 is moved relative to the holder 112 in an opposite direction so as to conceal the blade 20. The motor can be turned on so as to pivot the pivotal upper jaw up and down for scissoring. If the environment is dark, the light source 14 can be turned on for illumination of an area of a piece of paper or the like in which cutting is desired.

The present invention has been described through detailed illustration of the preferred embodiment. Those skilled in the art can derive many variations from the preferred embodiment without departing from the scope of the present invention. Therefore, the preferred embodiment shall not limit the scope of the present invention. The scope of the present invention is defined in the attached claims.

1. A multi-functional cutter including a handle (10), a stationary jaw (11) secured to the handle (10), a first blade (111) secured to the stationary jaw (11), a pivotal jaw (12) connected with the handle (10), a second blade (121) secured to the pivotal jaw (12) so that the first and second blades (111, 121) face each other, and a third blade (20) mounted on the stationary jaw (11).

2. The multi-functional cutter according to claim 1 wherein the stationary jaw (11) includes a holder (112) formed thereon for holding the third blade (20).

3. The multi-functional cutter according to claim 2 wherein the holder (112) includes a first side on which two bosses (114) are formed, and the third blade (20) includes two apertures (21) defined therein for receiving the bosses (14).

4. The multi-functional cutter according to claim 3 wherein the holder (112) includes a raised portion (113) formed on the first side, and the third blade (20) includes a rear edge located against the raised portion (13) of the holder (12).

5. The multi-functional cutter according to claim 2 including a sheath (30) movably mounted on the holder (112) for concealing the third blade (20).

6. The multi-functional cutter according to claim 5 wherein the sheath (30) includes a first side plate (31) and a second side plate (32) connected with the first side plate (31) so that the holder (112) and the third blade (20) are located between the side plates (31, 32).

7. The multi-functional cutter according to claim 6 wherein one of the holder (112) and the first plate (31) of the sheath (30) includes a groove (115) defined therein, and the remaining one of the holder (112) and the first plate (31) of the sheath (30) includes a ridge (33) formed thereon for insertion in the groove (115).

8. The multi-functional cutter according to claim 7 wherein the holder (112) includes a groove (115) defined therein, and the first plate (31) of the sheath (30) includes a ridge (33) formed thereon for insertion in the groove (115).

9. The multi-functional cutter according to claim 1 including a frame (16) formed on the handle (11) for holding a spare blade (20).

10. The multi-functional cutter according to claim 9 wherein the frame (16) includes a horizontal ridge and two vertical ridges from each of which a rim (162) projects for avoiding escaping of the spare blade (20) from the frame (16) laterally.

11. The multi-functional cutter according to claim 10 wherein the rims (162) are away from the handle (11) by a distance equal to the thickness of the spare blade (20).

12. The multi-functional cutter according to claim 10 including a cover (18) movably mounted on the frame (16) for concealing the spare blade (20).

13. The multi-functional cutter according to claim 12 wherein each of the rims (162) defines a groove (161), and the cover (18) includes two vertical edges (181) for insertion in the grooves (161) and an upper edge (182) for avoiding escaping of the spare blade (20) from the frame (16) vertically.

14. The multi-functional cutter according to claim 1 including a light source (14) mounted on the handle (10).

15. The multi-functional cutter according to claim 14 including a switch (15) mounted on the handle (10) for controlling the light source (14).
